(19) United States
(12) Patent Application Publication
(10) Pub. No.: US 2014/0209429 A1
(43) Pub. Date: Jul. 31, 2014

(54) PARK MECHANISM FOR A MOTOR VEHICLE

(71) Applicant: FORD GLOBAL TECHNOLOGIES, LLC, DEARBORN, MI (US)

(72) Inventors: Jeffrey J. Tumavitch, Livonia, MI (US); Brian J. Deurloo, Howell, MI (US); Richard R. Hathaway, Livonia, MI (US)

(73) Assignee: FORD GLOBAL TECHNOLOGIES, LLC, DEARBORN, MI (US)

(21) Appl. No.: 13/751,265

(22) Filed: Jan. 28, 2013

(51) Int. Cl. F16H 63/34

(52) U.S. Cl. CPC F16H 63/3425
USPC 192/219.5

(57) ABSTRACT

A park mechanism includes a cam pivotal between Park and not-Park ranges, including a radial outer surface formed with angularly spaced lobes, a roller urged by a spring into contact with the outer surface, a park spring urging the cam toward the Park-range, a power source for pivoting the cam, and a pawl actuated by cam movement into a Park state and a not-Park state.

### BACKGROUND OF THE INVENTION

1. Field of the Invention

This invention relates generally to a parking mechanism that provides both stable Park and non-Park positions without external power being applied. This is primarily useful for Shift-by-Wire systems that lack a driver actuated mechanical linkage to the parking pawl.

2. Description of the Prior Art

Parking mechanisms or assemblies are used in automotive vehicles to allow the vehicle to enter into and maintain a “parked” condition or state. Parking assemblies typically include a park rod, which selectively actuates a parking pawl, which operatively engages the vehicle's park gear, thereby maintaining the vehicle in a “parked” position or state.

The park rod is typically mechanically linked to the vehicle's shifter and moves in response to shifter movement. When the shifter is moved to the “park” position, the park rod engages the parking pawl, which pivots or rotates into a position where it is disposed between a pair of teeth on the park gear, thereby substantially preventing the park gear and the output shaft from further rotating.

A need exists in a shift-by-wire park mechanism, to remain in Park, thereby securing the vehicle when power is off, to remain in Neutral when power is off to support towing the vehicle, and to provide a mechanical override to enter and exit Park.

### SUMMARY OF THE INVENTION

A park mechanism includes a cam pivotal between Park and not-Park ranges, including a radial outer surface formed with angularly spaced lobes, a roller urged by a spring into contact with the outer surface, a park spring urging the cam toward the Park-range, a power source for pivoting the cam, and a pawl actuated by cam movement into a Park state and a not-Park state.

Using a modification of a standard rooster comb, this mechanism is capable of maintaining both Park and non-Park positions without external power being provided.

Unless a specific control action is taken to stay out of Park, the mechanism will secure the vehicle into Park if power is removed from the mechanism.

The mechanism is mechanically stable in either a Park or non-Park state without additional energy input.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### DESCRIPTION OF THE DRAWINGS

The invention will be more readily understood by reference to the following description, taken with the accompanying drawings, in which:

FIG. 1 is a side view of a park brake mechanism;

FIG. 2 is a perspective view of a park brake assembly for an automatic transmission.

### DESCRIPTION OF THE PREFERRED EMBODIMENT

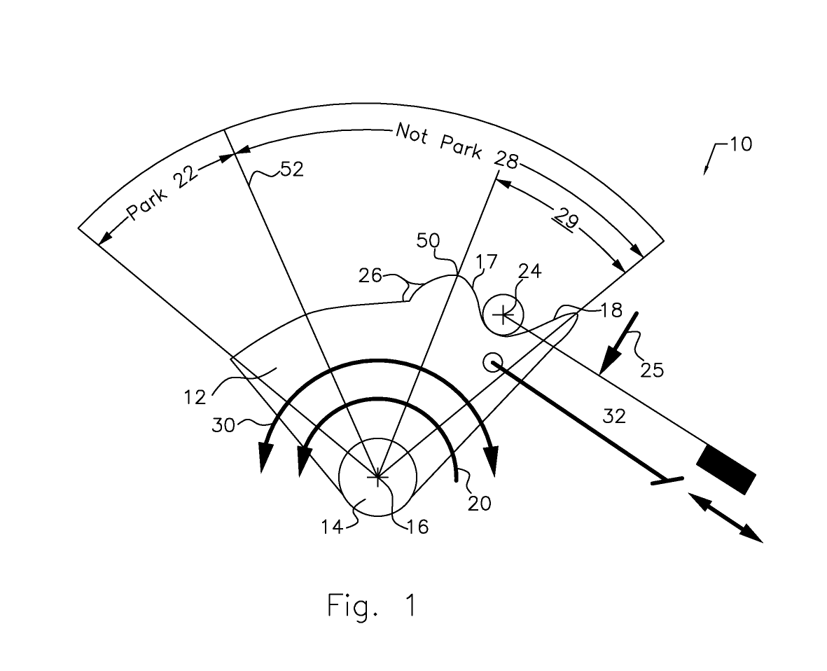

The park mechanism 10 of FIG. 1 includes a cam 12, similar to a modified rooster comb; a shaft 14, to which the cam 12 is secured to pivot about an axis 16; lobes 17, 18 having inclined surfaces spaced mutually angularly about the axis; a spring 20, which applies torque to the cam 12 tending to rotate the cam counterclockwise (when viewed as in FIG. 1) toward the Park range 22; and a roller 24 biased by a spring 25 into rolling contact with the radial outer surface 26 of the cam between lobes 17, 18. Preferably spring 25 is a compression spring and spring 20 is a torsion spring.

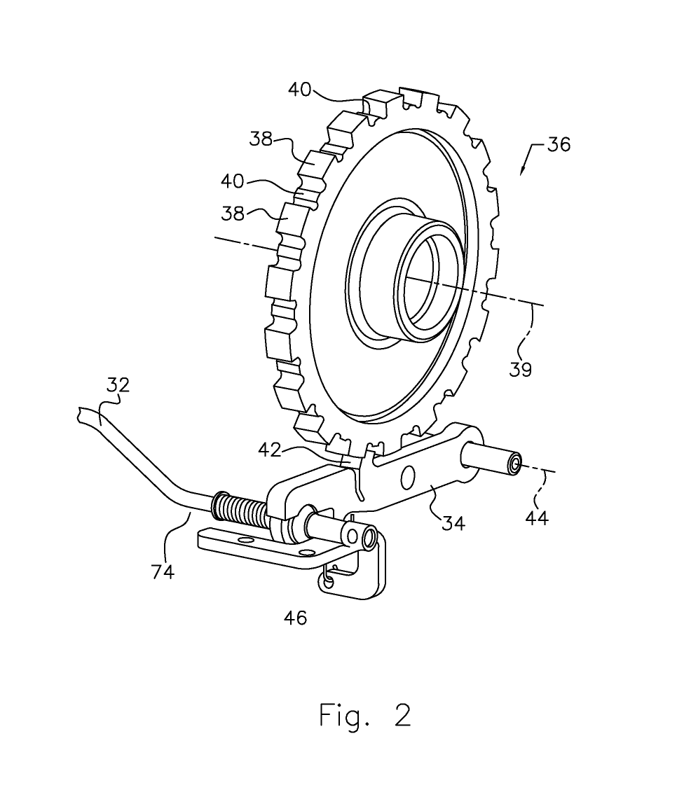

The cam is divided into a Park range 22 and a not-Park range 28. The crests of lobes 17, 18 define a range 29 within the not-Park range 28, wherein the mechanism holds the park mechanism of FIG. 2 out of Park. Movement of the roller 24 on either of the inclined surfaces of lobes 17, 18 opposes and resists rotation of the cam 12, tending to hold the cam out of Park, i.e., out of the Park range 22.

A source of power 30, such as an electric motor or hydraulic pressure, applies alternately both clockwise and counterclockwise torque to cam 12. Torque produced by the power source 30 is able to overcome both the torque applied to the cam by the park spring 20 and resistance to rotation of the cam produced by roller 24 and the spring that urges the roller into contact with the cam.

A lever arm 32, secured to cam 12, is secured also to a parking pawl 34, shown in FIG. 2, for use in combination with a vehicle of the type having a park gear 36 and a shifter (not shown) for selecting the operating range of an automatic transmission, whose output shaft is aligned with axis 39 and secured to park gear 36.

Park gear 36 includes several peripherally disposed and substantially identical teeth or projections 38. Each tooth 38 is separated by a recess 40. When the angular position of cam 12 is as shown in FIG. 1, the parking pawl 34, which includes a tooth 42, pivots about axis 44 to engage park a recess 40 between teeth 38 of park gear 36, thereby substantially preventing the park gear 36, transmission output shaft and vehicle wheels from rotating. When the angular position of cam 12 is rotated counterclockwise from the position shown in FIG. 1, pawl 34 pivots about axis 44, due to the force of a spring is 46, thereby disengaging the pawl from park gear 36 and allowing the park gear, transmission output shaft and vehicle wheels to rotate freely about axis 39.

To exit the Park range 22, the power source 30 must rotate shaft 14 clockwise with sufficient torque to overcome the torque of spring 20, which urges the cam 12 toward the Park range 22. If cam 12 rotates clockwise such that roller 24 passes crest 50 and enters the region between lobes 17, 18, the mechanism 10 will be maintained in the non-Park state without additional force or torque being applied.

The necessary input rotation of cam 12 produced by power source 30 can be accomplished by using hydraulic pressure to oppose spring 20, which urges cam 12 toward the Park range 22, and, if necessary, the force applied by spring 25 applied to roller 24 as it moves over the crest 50 of lobe 17.

When the power source 30 is hydraulic pressure, the mechanism 10 is insensitive to a temporary loss of electrical power as long as hydraulic pressure is maintained. A disadvantage is that the mechanism cannot exit park if the engine (or other hydraulic pressure generating system) is off.

As an alternative to hydraulic actuation, shaft 14 can be rotated using an electrical motor. The advantage of this is that the mechanism can enter or exit Park range 22 even with the vehicle's engine being off.

The mechanism's output transmitted on lever arm 32 is connected to a standard parking pawl mechanism, as described with reference to FIG. 2. This output provides all the standard features of a conventional transmission including ratcheting above a set speed.

If shaft 14 is extended outside the transmission case, the Park mechanism can be manually actuated to enter or exit Park range 22.

The mechanism 10 can easily be modified to stay in Neutral, i.e., to default to neutral instead of defaulting to Park upon loss of torque from the power source 30, provided crest 50 of lobe 17 is located at the boundary 52 between Park range 22 and not-Park rage 28, instead of at the location shown in FIG. 1. If the mechanism is modified to “default to Neutral” then the pawl 34 will be mechanically held away from the park gear 36 and no ratcheting will occur.

In accordance with the provisions of the patent statutes, the preferred embodiment has been described. However, it should be noted that the alternate embodiments can be practiced otherwise than as specifically illustrated and described.

The invention claimed is:

1. A park mechanism, comprising:
a cam pivotal between Park and not-Park ranges, including a radial outer surface formed with angularly spaced lobes;
a roller urged by a spring into contact with the outer surface;
a park spring urging the cam toward the Park-range;
a power source for pivoting the cam;
a pawl actuated by cam movement into a Park state and a not-Park state.

2. The park mechanism of claim 1, further comprising a park gear secured to a transmission output shaft and alternately engaged and disengaged by the pawl in response to movement of the cam.

3. The park mechanism of claim 1, wherein each of the lobes includes an inclined surface, movement of the roller on one of the inclined surfaces tending to increase resistance of cam rotation toward the Park-range.

4. The park mechanism of claim 1, wherein the park spring is a torsion spring that applies torque to the cam urging the cam toward the Park-range.

5. The park mechanism of claim 1, wherein the power source is an electric motor.

6. The park mechanism of claim 1, wherein the power source is hydraulic pressure.

7. The park mechanism of claim 1, wherein the spring is a compression spring that applies force to the roller urging the roller against the outer surface.

8. The park mechanism of claim 1, wherein the lobes define, within the not-Park range, a held-out-of Park range wherein the pawl is located in the not-Park state.

9. A park mechanism, comprising:
a cam pivotal between Park and not-Park ranges, including a radial outer surface formed with a first lobe located at a boundary between the Park and not-Park ranges and a second lobe spaced from the first lobe;
a roller urged by a spring into contact with the outer surface;
a park spring urging the cam toward the Park-range;
a power source for pivoting the cam;
a pawl actuated by cam movement into a Park state and a not-Park state.

10. The park mechanism of claim 9, further comprising a park gear secured to a transmission output shaft and alternately engaged and disengaged by the pawl in response to movement of the cam.

11. The park mechanism of claim 9, wherein each of the lobes includes an inclined surface, such that movement of the roller on one of the inclined surfaces increases resistance of cam rotation toward the Park-range.

12. The park mechanism of claim 9, wherein the power source is an electric motor.

13. The park mechanism of claim 9, wherein the power source is hydraulic pressure.

14. The park mechanism of claim 9, wherein the lobes define, within the not-Park range, a held-out-of Park range wherein the pawl is located in the not-Park state.

15. A method for operating a park mechanism, comprising
(a) supporting a cam to pivotal between Park and not-Park ranges on a radial outer surface formed with angularly spaced lobes;
(b) using a spring to urge a roller into contact with the outer surface;
(c) using a park spring to urge the cam toward the Park-range;
(d) using a power source to pivoting the cam;
(e) using cam movement to move a park pawl between Park and not-Park states.

16. The method of claim 15, further comprising:
securing a park gear to a transmission output;
using movement of the pawl alternately to engage the park gear, thereby holding the output against rotation, and to disengage the park gear, thereby allowing the output to rotate.

17. The method of claim 15, wherein step (d) further comprises using an electric motor to pivot the cam.

18. The method of claim 15, wherein step (d) further comprises using hydraulic pressure to pivot the cam.
